(19) United States
(12) Patent Application Publication
(10) Pub. No.: US 2018/0034351 A1
(43) Pub. Date: Feb. 1, 2018

(54) METHOD FOR WINDING A STATOR OF A ROTARY ELECTRICAL MACHINE, AND CORRESPONDING WOUND STATOR

(71) Applicant: VALEO EQUIPEMENTS ELECTRIQUES MOTEUR, Creteil Cedex (FR)

(72) Inventors: Vincent RAMET, Etaples (FR); Alain DEFEBVIN, Cormont (FR); Jean DUQUESNE, Etaples sur Mer (FR); Jérôme FOURNIER, Boulogne Sur Mer (FR); Stéphane DE-CLERCQ, Rang du Fliers (FR); Sébastien LECLERCQ, Humbert (FR); Geoffroy WILQUIN, Merck-Saint-Liévin (FR)

(21) Appl. No.: 15/552,902

(22) PCT Filed: Mar. 3, 2016
(86) PCT No.: PCT/FR2016/050491

§ 371 Date: Aug. 23, 2017

(30) Foreign Application Priority Data
Mar. 5, 2015 (FR) 1551834

(51) Int. Cl. H02K 15/085; H02K 1/16; H02K 3/34; H02K 3/12; H02K 3/28

(52) U.S. Cl. CPC H02K 15/085; H02K 3/12; H02K 3/28; H02K 3/345; H02K 1/16; H02K 1/243

(57) ABSTRACT

The invention relates mainly to a method for winding a stator for a multiphase electric machine, the stator comprising notches and intended to receive conductors of a winding, the winding comprising, for each phase, a coil and forming two systems each comprising a respective group of coils, the method comprising steps of installing conductors in the repeated notches in such a way as to form a winding comprising a plurality of concentric turns, wherein one of the steps of installing the conductors in a series of notches is subdivided into a first step of installing the conductors of a first turn of the first system; followed by a second step of installing the conductors of the first turn of the second system while the first step of installing the conductors of the first system continues.

The present invention relates to a method for winding a stator of a rotary electrical machine, as well as to the corresponding wound stator. The invention has a particularly advantageous application for a stator of a rotary electrical machine, such as, for example, an alternator, an alternator-starter, or an electric motor.

In a known manner, rotary electrical machines comprise a stator and a rotor integral with a shaft. The rotor can be integral with a driving and/or driven shaft, and can belong to a rotary electrical machine in the form of an alternator, as described in document EP0803962, or an electric motor as described in document EP0831580. The electrical machine comprises a casing which supports the stator. This casing is also configured to rotate the shaft of the rotor, for example by means of bearings.

This alternator comprises in particular a housing, and, inside the latter, a claw rotor which is integral in rotation directly or indirectly with a shaft, and a stator, which surrounds the rotor with the presence of a small air gap. The rotor comprises a coil and a pair of magnet wheels consisting of a cylindrical portion which supports the coil of the rotor, as well as disc portions which extend from the ends of the cylindrical portion. In addition, a plurality of magnetic poles in the form of claws extend axially from the said disc portions, such as to cover the rotor coil. The claws of one magnet wheel face axially towards the other magnet wheel, with the claw of one magnet wheel penetrating in the space which exists between two adjacent claws of the other magnet wheel, such that the claws of the magnet wheels are imbricated relative to one another. The outer periphery of the claws has axial orientation, and defines with the inner periphery of the stator body the air gap between the stator and the rotor. The inner periphery of the claws is inclined, the claws being thinner at their free end.

As a variant, the rotor comprises a body formed by a stack of sheets of metal plates which are retained in the form of a set by means of an appropriate securing system, such as rivets which pass through the rotor axially from one side to the other. The rotor comprises poles which are formed for example by permanent magnets accommodated in cavities provided in the magnetic mass of the rotor, as described for example in document EP0803962. Alternatively, in a so-called “projecting” poles architecture, the poles are formed by coils which are wound around arms of the rotor.

The stator comprises a body constituted by a stack of thin metal plates, as well as a phase winding which is received in the notches of the stator which are open towards the interior. There are generally three or six phases. In the stators of alternators of this type, the most commonly used types of windings are firstly so-called “concentric” windings, constituted by coils closed on themselves which are wound around teeth of the stator, and secondly windings of the so-called “undulating” type.

An undulating winding comprises a plurality of phase windings, each phase winding comprising a spiral conductor, each turn of which forms undulations which pass through the notches in the body. Thus, in each turn, the conductor has loop structures which are situated alternately on both sides of the rotor or the stator, connecting to one another segment structures which are situated inside the notches in the stator. The conductor can be formed by one or a plurality of electrically conductive wires.

Document FR2947968 teaches the implementation of an in situ winding method in which all of the phase windings are wound at the same time and in parallel in the corresponding notches in the stator body. In the case of a hexaphase winding comprising two three-phase systems, this means that the inputs of the two systems which are obtained at the beginning of the winding are grouped together in a single area, whereas the outputs of the two systems obtained at the end of the winding are grouped together in a distinct area, spaced from the input area.

Consequently, in the case when it is wished to carry out coupling of the two three-phase systems, it is necessary to carry out a complementary operation of orientation and binding of phase windings in order to group together firstly the inputs and outputs of the first three-phase system, and secondly the inputs and outputs of the second three-phase system, or to group together one or a plurality of phase windings of the first system with one or a plurality of phase windings of the second system, such as to create two three-phase systems. However, a complementary binding operation of this type is lengthy and costly to carry out on an assembly line.

The objective of the invention is to eliminate this disadvantage efficiently by proposing a method for winding a stator for a multiphase electrical machine, the said stator comprising notches which are designed to receive conductors of a winding, the said winding comprising a winding for each phase, and forming two systems each comprising a respective group of windings, the said method comprising steps of installation of the conductors in the said notches, repeated such as to form a winding comprising a plurality of concentric turns.

According to one characteristic, one of the steps of installation of the conductors in a series of notches is subdivided into a first step of installation of at least one of the conductors of a first turn of the first system, followed by a second step of installation of at least one of the conductors of the first turn of the second system, whereas the first step of installation of at least one of the conductors of the first system is continued.

The invention thus makes it possible to position the inputs of the two systems in two different locations, which facilitates the coupling of the two systems by permitting positioning of the inputs opposite the corresponding control electronics. The invention thus makes it possible to eliminate the step of orientation and binding carried out in the methods according to the prior art.

According to one embodiment, during the step of installation of at least one of the conductors of a first turn of the first system, all the conductors of a first turn of the first system are installed, and during the second step of installation of at least one of the conductors of the first turn of the second system, all the conductors of the first turn of the second system are installed.

According to one embodiment, the said subdivided installation step also comprises a first step of installation of the conductors of a final turn of the first system, and a second step of installation of the conductors of the final turn of the second system, the said first step of installation of the conductors of the final turn of the first system ending before the second step of installation of the conductors of the final turn of the second system.

The invention also makes it possible to position the outputs of the two systems in two different locations, which facilitates the coupling of the two systems by permitting positioning of the outputs opposite the corresponding control electronics.

According to one embodiment, the second step of installation of the conductors of the final turn of the second system is continued, whereas the first step of installation of the conductors of the final turn of the first system ends, in a number of notches corresponding to a predetermined angle of the said stator.

According to one embodiment, the said first and second steps of installation of the conductors of the final turn are triggered simultaneously.

According to one embodiment, the said first and second steps of installation of at least one of the conductors of the first turn end simultaneously.

According to one embodiment, the portions of the conductors of the first turn which are installed firstly in the said notches during the first or second step of installation of at least one of the conductors of the first turn correspond respectively to the inputs of the winding of the first system or of the second system.

According to one embodiment, with the parts of a conductor which connect the two parts of this conductor which are installed in two consecutive notches being loop structures, the method also comprises a step of drawing at least one of the loop structures such as to form an excess length, followed by a step of passage of an input wire of the winding through the said excess length, such that the said input wire is retained.

According to one embodiment, the portions of the conductors the final turn which are installed finally in the said notches during the first or second step of installation of the conductors of the final turn correspond respectively to the outputs of the winding of the first system or of the second system.

According to one embodiment, with the parts of a conductor which connect the two parts of this conductor installed in two consecutive notches being loop structures, the method also comprises a step of drawing at least one of the loop structures, such as to form an excess length, followed by a step of passage of an output wire of the winding through the said excess length, such that the said output wire is retained.

According to one embodiment, the second step of installation of at least one of the conductors of the first turn of the second system is triggered when a number of notches corresponding to a predetermined angle of the said stator is covered by the first step of installation of at least one of the conductors of the first turn of the first system.

The invention also relates to a stator of a multiphase electrical machine, the said stator comprising notches which are designed to receive conductors of a winding, the said winding comprising a winding for each phase, and forming two systems each comprising a respective group of windings, the said winding comprising a plurality of concentric turns formed by conductors in a series of notches, characterised in that the first turn comprises conductors of the first system which are installed in a first series of notches, and conductors of the second system which are installed in a second series of notches, the number of notches of the first series filled by the conductors of the first system being greater than that of the number of notches of the second series filled by the conductors of the second system.

According to one embodiment, the final turn comprises conductors of the first system which are installed in a first series of notches, and conductors of the second series which are installed in a second series of notches, the number of notches of the first series filled by the conductors of the first system being smaller than the number of notches of the second series filled by the conductors of the second system.

According to one embodiment, the sum of the number of notches of the first series which are filled by the conductors of the first system in the first turn and the final turn is equal to the sum of the number of notches of the second series which are filled by the conductors of the second system in the first turn and the final turn.

The invention will be better understood by reading the following description and examining the figures which accompany it. These figures are provided purely by way of illustration, and in no way limit the invention.

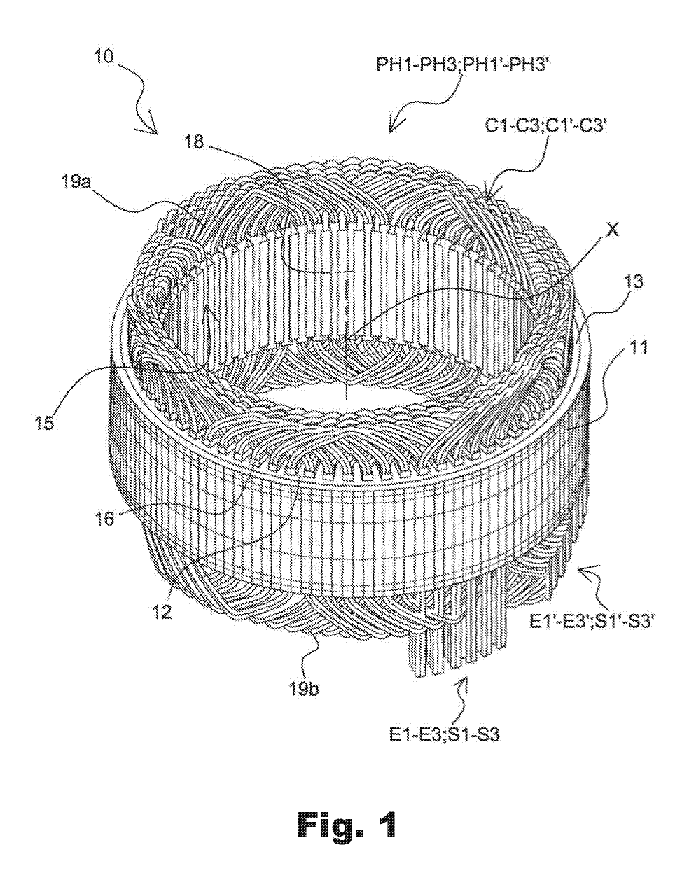

FIG. 1 is a view in perspective of a wound stator obtained further to implementation of the winding method according to the present invention;

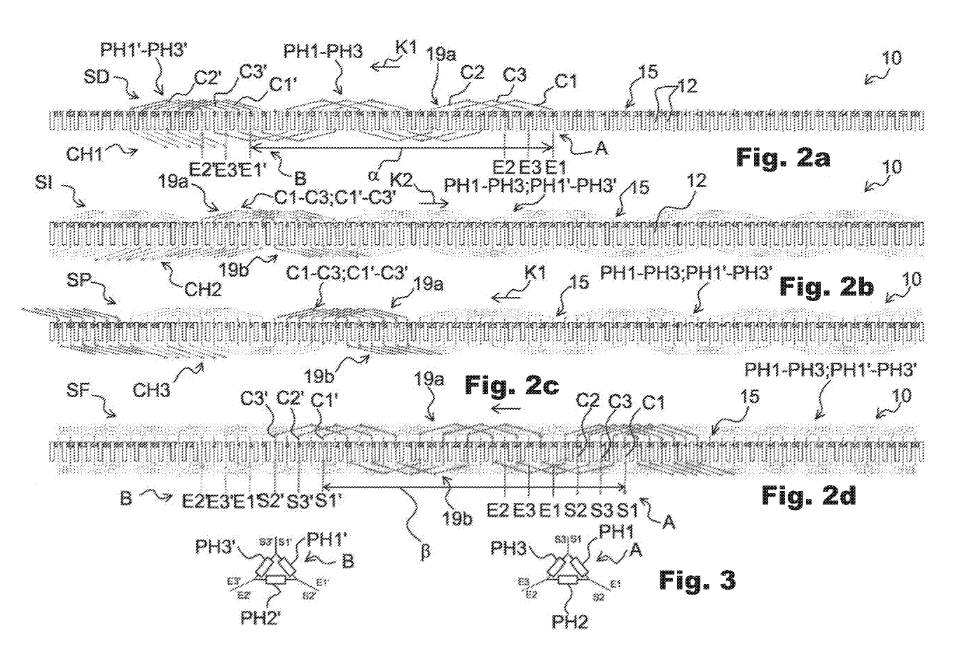

FIGS. 2a to 2d illustrate, for a stator represented in flat projection, the different types of turns obtained during implementation of the winding method according to the present invention;

FIG. 3 illustrates the coupling of the two three-phase systems obtained further to implementation of the method according to the present invention;

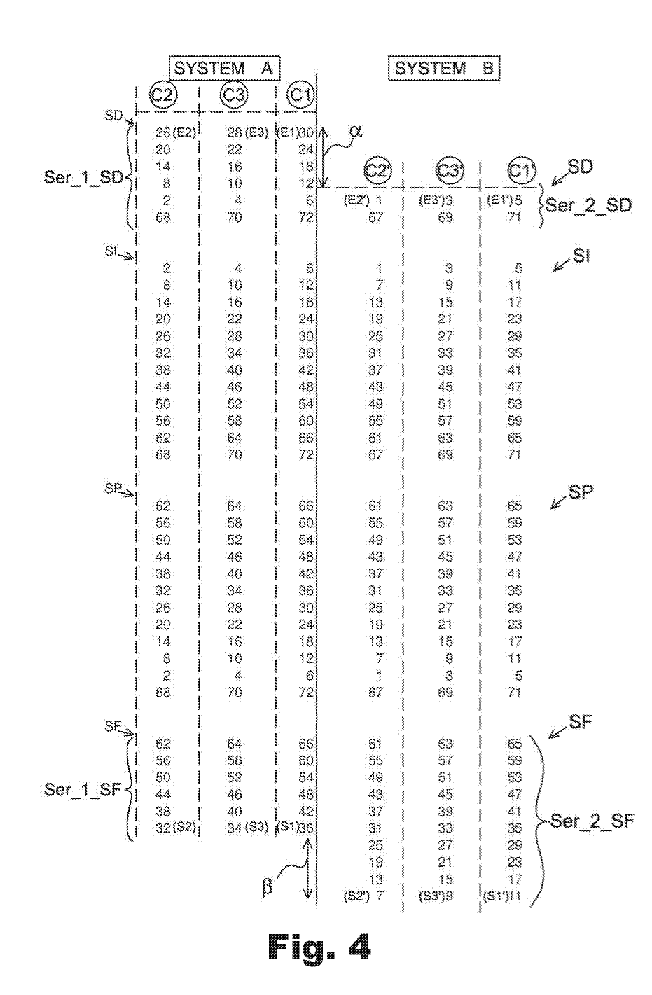

FIG. 4 is the list of the numbers of notches filled by the conductors of the phases of the different systems respectively during the creation of the starting turn, odd turns, even turns, and the final winding turn;

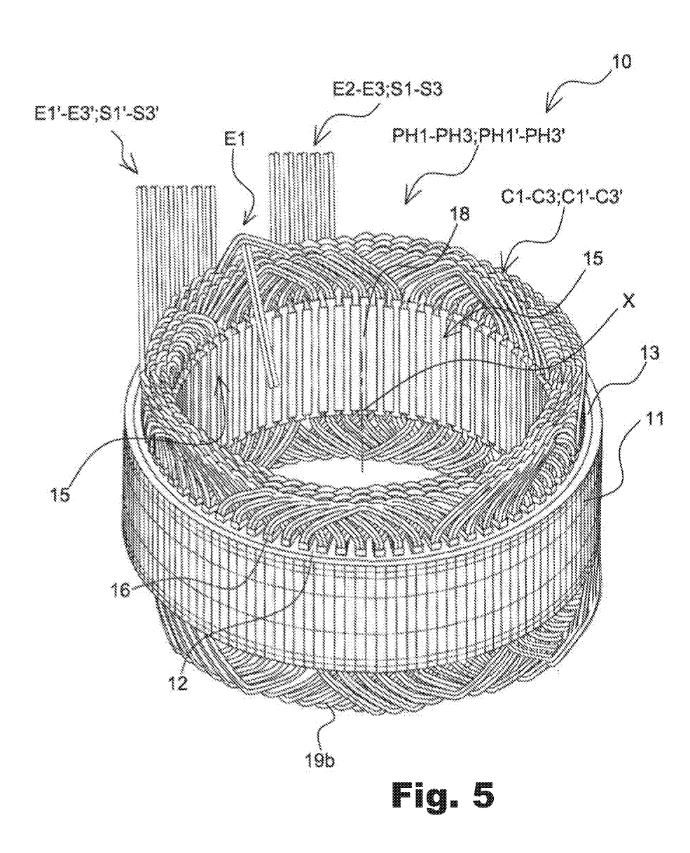

FIG. 5 illustrates a step of passage of an input wire of the winding into a loop structure.

Elements which are identical, similar or analogous retain the same reference from one figure to another.

FIG. 1 is a view in perspective of a wound stator 10 of a rotary electrical machine which comprises mainly a body 11 in which there are fitted a plurality of phase windings PH1-PH3; PH1′-PH3′forming a winding. The rotary machine is for example an alternator or an alternator-starter. This machine is preferably designed to be implemented in a motor vehicle. It will be remembered that an alternator-starter is a rotary electrical machine which can work reversibly, firstly as an electric generator when functioning as an alternator, and secondly as an electric motor, in particular in order to start the thermal engine of the motor vehicle.

The stator body 11 has an annular cylindrical form with an axis X, and consists of an axial stack of flat metal plates. The body 11 comprises teeth 12 which are distributed angularly regularly around an inner circumference of a head 13. These teeth 12 delimit notches 15 in pairs. The head 13 corresponds to the solid annular portion of the body 11, which extends between the base of the notches 15 and the outer periphery of the body 11.

The notches 15 open axially on both sides of the body 11. The notches 15 are also open radially in the inner face of the body 11. The notches 15 can have parallel edges, i.e. the inner faces opposite one another are parallel to one another. Alternatively, in another configuration, teeth 12 with parallel edges can be found, and in this case the notches are known as trapezoidal. There are for example 36, 48, 60, 72, 84 or 96 notches 15. In this embodiment, the stator 10 comprises 72 notches. Preferably, the stator 10 is without tooth roots, in order to facilitate the insertion of the conductors during the winding step. Alternatively, in another configuration, the teeth 12 can be provided with tooth roots. Insulators 16 are arranged in the notches 15 in the stator.

In order to form the stator winding 10, a plurality of phase windings PH1-PH3, PH1′-PH3′ are installed in the notches 15 in the body 11. In this case, the hexaphase stator comprises six phase windings in order to form two three-phase systems coupled to one another. The invention is however applicable to stators comprising a larger number of three-phase systems, or to systems each comprising a number of phase windings different from three windings.

Each phase winding PH1-PH3, PH1′-PH3′ is constituted by a conductor C1-C3, C1′-C3 which is bent in a serpentine form, and wound inside the stator in the notches 15 in order to form a turn, with the winding of a plurality of concentric turns forming the winding of the complete phase. Each notch 15 receives the conductor C1-C3, C1′-C3′ of a single phase several times, and thus when there are N phases, the conductors of a single phase winding PH1-PH3, PH1′-PH3′ is inserted every N notches 15.

In each turn, the conductor C1-C3, C1′-C3′ thus has loop structures 19a, 19b which are situated alternately on both sides of the rotor or the stator, connecting to one another segment structures 18 which are situated in a series of notches 15 associated with a given phase winding. It should be noted that each conductor C1-C3, C1′-C3′ can comprise a single wire or a bundle M of conductive wires, M being equal to 2 or more. In this case, the wires have a round cross-section. Alternatively, in order to optimise the filling of the notches 15, the wires can have a rectangular or square cross-section. The conductors are preferably made of copper covered with enamel.

With reference to FIGS. 2a to 2d, a description is provided hereinafter of the method which makes it possible to obtain the hexaphase wound stator 10 (N=6) comprising a first three-phase system A formed by the phase windings PH1-PH3, and a second three-phase system B formed by the windings PH1′-PH3′. Each phase winding PH1-PH3, PH1′-PH3′ is constituted by a corresponding wound conductor C1-C3, C1′-C3′. In this case, the conductors C1-C3, C1′-C3′ each comprise a bundle of M=2 wires, even though a single wire per conductor has been represented in the figures in order to facilitate understanding of the method.

More specifically, as illustrated in FIG. 2a, a first step of installation of the conductors C1-C3 of the first system A is carried out so as to form a first turn, known as a starting turn SD. For this purpose, the conductors C1-C3 are inserted in three distinct notches 15 corresponding to the first system A. Two adjacent notches 15 of this assembly are spaced from one another by a notch which is left free in order to permit subsequent insertion of the conductors C1′-C3′ of the second three-phase system B, as explained hereinafter. In the example represented, the conductors C1-C3 of the first system A are inserted in the notches which are numbered respectively 26, 28 and 30.

The portions of the conductors C1-C3 of the starting turn which are installed first in the notches 15 during this first installation step correspond to the inputs E1-E3 of the winding of the first system.

The conductors C1-C3 of the first system A are then bent in order to form loop structures 19a, in this case with a substantially triangular form, which extend from a single side of the stator 10. The conductors C1-C3 of the first system A are then each inserted in the following notch 15, which is situated N notches after the first. The conductors C1-C3 are then bent in order to form loop structures 19b which extend from a side opposite that of the first loop structures 19a. Thus, the loop structures 19a, 19b are situated on the exterior of the stator 10, alternately on one side or the other of the stator, with the assembly of the loop structures 19a, 19b which extend from a single side of the stator 10 forming a winding chignon.

The winding of the first system A alone thus continues to be formed until a number of notches 15 corresponding to a predetermined angle α of the stator 10 is covered by the first step of installation of the conductors C1-C3 of the first system A. This angle α is predetermined such that the inputs E1-E3; E1′-E3′ of the two three-phase systems A, B are situated respectively opposite the corresponding control electronics.

When this predetermined angle α is reached, for example an angle α of approximately 120°, a second step of installation of the conductors C1-C3′ of the starting turn SD of the second system B is carried out. For this purpose, the portions of the conductors C1′-C3′ of the second system B corresponding to the inputs E1′-E3′ are inserted in the free notches 15 situated between the notches filled by the first system A, as well as in an adjacent notch 15, such as to have alternately a notch 15 which receives a conductor of one of the systems A, B, then a notch 15 which receives a conductor of the other system A, B. The conductors C1′-C3′ of the second system B can thus for example be inserted in the notches 15 which are numbered respectively 1, 3 and 5, whereas the conductors C1-C3 of the first system A are in the notches 15 which are numbered respectively 2, 4 and 6 (cf. FIG. 4).

With the step of installation of the conductors C1-C3 of the first system A continuing, simultaneous winding is then carried out of the two three-phase systems A, B. In other words, simultaneous winding in parallel is carried out of the N conductors C1-C3, C1′-C3′ in the successive series of N notches 15. With the winding of the systems A, B having been carried out in a first direction K1 during the winding of the starting turn SD, a change of direction CH1 then takes place, represented in broken lines, in order to go to a second direction of winding K2, so as to form an odd turn SI, as illustrated in FIG. 2b.

The two systems A, B are then wound simultaneously in the odd turn SI according to a complete revolution of the stator 10, i.e. all the notches 15 in the stator 10 are filled in succession by a series of N notches by the two systems A, B, in the direction K2 (cf. FIG. 4).

When the revolution of the odd turn SI is completed, a change of direction CH2 takes place, in order to return to the direction of winding K1, so as to carry out an even turn SP, as illustrated in FIG. 2c. The two systems A, B are then wound simultaneously in the even turn SP according to a complete revolution of the stator 10, i.e. all the notches 15 in the stator 10 are filled in succession by a series of N notches by the two systems A, B, in the direction K1 (cf. FIG. 4).

It should be noted that during a phase of winding in the inverse direction, each loop structure 19a, 19b of a conductor C1-C3, C1′-C3′ belonging to a given winding PH1-PH3; PH1′-PH3′ will be placed in the free space between two loop structures 19a, 19b of the conductors C1-C3, C1′-C3′ obtained during the winding phase in the first direction. A symmetrical winding of the distributed undulating type is thus obtained.

When the revolution of the even turn SP has been completed, a further change of direction CH3 takes place in order to form a new odd turn SI, and so on, until the required number of turns has been obtained. If it is wished to carry out six complete turns (without counting the starting turn SD or the end of winding turn SF), there are thus three changes of direction CH2 in order to go from the turns 1/3/5 formed in the direction K2 to the turns 2/4/6 formed in the direction K1. In addition, there are two changes of direction CH3 in order to go from the turns 2/4 formed in the direction K1 to the turns 3/5 formed in the direction K2.

In the present case, the direction K1 corresponds to the insertion of the conductors C1-C3, C1′-C3′ in decreasing series of notches 15, whereas the direction K2 corresponds to insertion of the conductors C1-C3, C1′-C3′ in increasing series of notches 15. However, as a variant, these two directions of winding K1, K2 could be inverted.

At the end of the winding process, and after having carried out a final change of direction, as illustrated in FIG. 2d a first step is carried out of installation of the conductors C1-C3 of the final turn SF of the first system A, and a second step of installation of the conductors C1′-C3′ of the final turn SF of the second system B.

These two installation steps are triggered simultaneously. However, the step of installation of the conductors C1-C3 of the final turn SF of the first system A ends before the step of installation of the conductors C1′-C3′ of the final turn SF of the second system B.

The portions of the conductors of the final turn SF which are installed last in the notches 15 during the first or second step of installation of the conductors C1-C3, C1′-C3′ of the final turn correspond respectively to the outputs S1-S3 of the winding of the first system A or to the outputs S1′-S3′ of the winding of the second system B.

It should be noted that the second step of installation of the conductors C1′-C3′ of the final turn SF of the second system B is continued, whereas the first step of installation of the conductors C1-C3 of the final turn SF of the first step A ends with a number of notches 15 corresponding to a predetermined angle β of the stator 10. This angle β, for example of approximately 120°, is predetermined such that the outputs S1-S3, S1′-S3′ of the two three-phase systems A, B are situated opposite the corresponding control electronics.

Thus, at the end of the process, the inputs E1-E3, E1′-E3′ and the outputs S1-S3, S1′-S3′ of each system are grouped together in the same area, such that it is easily possible to carry out the coupling in the form of a triangle of each of the three-phase systems A, B.

For this purpose, in the first system A, the input E1 of the first phase winding PH1 is connected to the output S2 of the second phase winding PH2, the output S1 of the first phase winding PH1 is connected to the output S3 of the third phase winding PH3, and the input E2 of the second phase winding PH2 is connected to the input E3 of the third phase winding PH3.

In addition, in the second system B, the input E1′ of the first phase winding PH1′ is connected to the output S2′ of the second phase winding PH2′, the output S1′ of the first phase winding PH1′ is connected to the output S3′ of the third phase winding PH3′, and the input E2′ of the second phase winding PH2′ is connected to the input E3′ of the third phase winding PH3′.

It will be appreciated that, as a variant, the three-phase systems A, B can be coupled in the form of a star. As an alternative, A can be coupled in the form of a star whereas B will be coupled in the form of a triangle.

As can be seen in FIG. 4, in the wound stator 10, the starting turn SD comprises conductors C1-C3 of the first system A installed in a first series of notches Ser_1_SD and conductors C1′-C3′ of the second system B installed in a second series of notches Ser_2_SD, with the number of notches 15 of the first series Ser_1_SD filled by the conductors C1-C3 of the first system A being greater than that of the number of notches of the second series Ser_2_SD filled by the conductors C1′-C3′ of the second system B. The difference between the number of notches of these two series Ser_1_SD and Ser_2_SD corresponds to the predetermined angle α between the inputs E1-E3; E1′-E3′ of the two systems A, B.

In addition, the final turn SF comprises conductors C1-C3 of the first system A installed in a first series of notches Ser_1_SF and conductors C1′-C3′ of the second system B installed in a second series of notches Ser_2_SF, with the number of notches 15 of the first series Ser_1_SF filled by the conductors C1-C3 of the first system A being smaller than the number of notches 15 of the second series Ser_2_SF filled by the conductors C1′-C3′ of the second system B. The difference between the number of notches of these two series Ser_1_SF and Ser_2_SF corresponds to the predetermined angle β between the inputs S1-S3, S1′-S3′ of the two systems A, B.

In addition, the sum of the number of notches 15 of the first series Ser_1_SD, Ser_1_SF filled by the conductors C1-C3 of the first system A in the first turn SD and the final turn SF is equal to the sum of the number of notches 15 of the second series Ser_2_SD, Ser_2_SF filled by the conductors C1′-C3′ of the second system B in the first turn SD and the final turn SF.

As illustrated in FIGS. 1, 4 and 5, the parts of a conductor which connect the two parts of this conductor accommodated or installed in two consecutive notches 15 are loop structures 19a or 19b.

A stator has been represented with a winding comprising inputs and outputs which are all situated on the outer diameter of the winding, i.e. in the layer of the winding which is furthest from the axis. It is also possible to provide a winding according to which the 3 inputs E1-E3 of the first system are situated on the inner diameter, i.e. in the layer of the winding which is closest to the axis, whereas the 3 outputs S1-S3 of the first system are situated on the outer diameter, i.e. in the layer of winding which is furthest from the axis. The same applies to the second system, i.e. it is also possible to provide a winding according to which the 3 inputs E′1-E′3 of the second system are situated on the inner diameter, i.e. in the layer of winding which is closest to the axis, whereas the 3 outputs S′1-S′3 of the second system are situated on the outer diameter, i.e. in the layer of winding which is furthest from the axis.

As illustrated in FIG. 5, it is possible to modify a loop structure 19a such as to form an excess length. It is then possible to pass an input wire E1 of the winding through the said excess length, such that the said input wire is retained. It would also be possible, instead of the input wire, to pass an output wire S1-S3, S1′-S3′ into the said excess length.

Similarly, it is also possible to modify a loop structure 19b such as to form an excess length. In this case, it is then possible to pass either an input wire or an output wire of the winding through the said excess length, such that the said input or output wire is retained.

It will be appreciated that the foregoing description has been provided purely by way of example, and does not limit the scope of the invention, a departure from which would not be constituted by replacing the different elements or steps by any other equivalents.

1. Method for winding a stator (10) for a multiphase electrical machine, said stator (10) comprising notches (15) which are designed to receive conductors (C1-C3, C1′-C3′) of a winding, said winding comprising a winding (PH1-PH3, PH1′-PH3′) for each phase, and forming two systems (A-B) each comprising a respective group of windings (PH1-PH3, PH1′-PH3′), said method comprising steps of installation of the conductors (C1-C3, C1′-C3′) in said notches (15), repeated such as to form a winding comprising a plurality of concentric turns (SD, SI, SP, SF),
wherein one of the steps of installation of the conductors (C1-C3, C1′-C3′) in a series of notches (15) is subdivided into a first step of installation of at least one of the conductors (C1-C3) of a first turn (SD) of the first system (A), followed by a second step of installation of at least one of the conductors (C1′-C3′) of the first turn (SD) of the second system (B), whereas the first step of installation of at least one of the conductors (C1-C3) of the first system (A) is continued.

2. Winding method according to claim 1, wherein, during the step of installation of at least one of the conductors (C1-C3) of a first turn (SD) of the first system (A), all the conductors (C1-C3) of a first turn (SD) of the first system (A) are installed, and during the second step of installation of at least one of the conductors (C1′-C3′) of the first turn (SD) of the second system (B), all the conductors (C1′-C3′) of the first turn (SD) of the second system (B) are installed.

3. Method according to claim 1, wherein said subdivided installation step also comprises a first step of installation of the conductors (C1-C3) of a final turn (SF) of the first system (A), and a second step of installation of the conductors (C1′-C3′) of the final turn (SF) of the second system (B), the said first step of installation of the conductors (C1-C3) of the final turn (SF) of the first system (A) ending before the second step of installation of the conductors (C1′-C3′) of the final turn (SF) of the second system (B).

4. Method according to claim 1, wherein the second step of installation of the conductors of the final turn (SF) of the second system (B) is continued, whereas the first step of installation of the conductors (C1-C3) of the final turn (SF) of the first system (A) ends with a number of notches (15) corresponding to a predetermined angle (β) of said stator (10).

5. Method according to claim 3, wherein said first and second steps of installation of the conductors (C1-C3, C1′-C3′) of the final turn (SF) are triggered simultaneously.

6. Method according to claim 1, wherein said first and second steps of installation of at least one of the conductors (C1-C3, C1′-C3′) of the first turn end (SD) simultaneously.

7. Method according to claim 1, wherein the portions of the conductors (C1-C3, C1′-C3′) of the first turn (SD) of the first or second system which are installed firstly in said notches (15) during the first or second step of installation of at least one of the conductors (C1-C3, C1′-C3′) of the first turn (SD) correspond respectively to the inputs (E1-E3, E1′-E3′) of the winding of the first system (A) or of the second system (B).

8. Method according to claim 7, with the parts of a conductor which connect the two parts of this conductor which are installed in two consecutive notches (15) being loop structures (19a, 19b), the method also comprises a step of drawing at least one of the loop structures such as to form an excess length, followed by a step of passage of an input wire (E1-E3, E1′-E3′) of the winding through the said excess length, such that said input wire is retained.

9. Method according to claim 1, wherein the portions of the conductors (C1-C3, C1′-C3′) of the final turn (SF) of the first or second system which are installed finally in said notches (15) during the first or second step of installation of the conductors (C1-C3, C1′-C3′) of the final turn (SF) correspond respectively to the outputs (S1-S3, S1′-S3′) of the winding of the first system (A) or of the second system (B).

10. Method according to claim 9, with the parts of a conductor which connect the two parts of this conductor installed in two consecutive notches (15) being loop structures, the method also comprises a step of drawing at least one of the loop structures, such as to form an excess length, followed by a step of passage of an output wire (S1-S3, S1′-S3′) of the winding through said excess length, wherein said output wire is retained.

11. Method according to claim 1, wherein the second step of installation of at least one of the conductors (C1′-C3′) of the first turn (SD) of the second system (B) is triggered when a number of notches (15) corresponding to a predetermined angle (α) of said stator (10) is covered by the first step of installation of at least one of the conductors (C1-C3) of the first turn (SD) of the first system (A).

12. Stator (10) of a multiphase electrical machine, said stator (10) comprising notches (15) which are designed to receive conductors (C1-C3, C1′-C3′) of a winding, said winding comprising a winding (PH1-PH3, PH1′-PH3′) for each phase, and forming two systems (A, B) each comprising a respective group of windings (PH1-PH3, PH1′-PH3′), said winding comprising a plurality of concentric turns (SD, SI, SP, SF) formed by conductors (C1-C3, C1′-C3′) in a series of notches (15),
wherein the first turn (SD) comprises conductors (C1-C3) of the first system (A) which are installed in a first series of notches (Ser_1_SD), and conductors (C1′-C3′) of the second system (B) which are installed in a second series of notches (Ser_2_SD), the number of notches (15) of the first series (Ser_1_SD) filled by the conductors (C1-C3) of the first system (A) being greater than that of the number of notches (15) of the second series (Ser_2_SD) filled by the conductors (C1′-C3′) of the second system (B).

13. Stator according to claim 12, wherein the final turn (SF) comprises conductors (C1-C3) of the first system (A) which are installed in a first series of notches (Ser_1_SF), and conductors (C1′-C3′) of the second system (B) which are installed in a second series of notches (Ser_2_SF), the number of notches (15) of the first series (Ser_1_SF) filled by the conductors (C1-C3) of the first system (A) being smaller than the number of notches (15) of the second series (Ser_2_SF) filled by the conductors (C1′-C3′) of the second system (B).

14. Stator according to claim 12, wherein the sum of the number of notches (15) of the first series (Ser_1_SD, Ser_1_SF) which are filled by the conductors (C1-C3) of the first system (A) in the first turn (SD) and the final turn (SF) is equal to the sum of the number of notches (15) of the second series (Ser_2_SD, Ser_2_SF) which are filled by the conductors (C1′-C3′) of the second system (B) in the first turn (SD) and the final turn (SF).

15. Method according to claim 2, wherein said subdivided installation step also comprises a first step of installation of the conductors (C1-C3) of a final turn (SF) of the first system (A), and a second step of installation of the conductors (C1′-C3′) of the final turn (SF) of the second system (B), said first step of installation of the conductors (C1-C3) of the final turn (SF) of the first system (A) ending before the second step of installation of the conductors (C1′-C3′) of the final turn (SF) of the second system (B).

16. Method according to claim 2, wherein the second step of installation of the conductors of the final turn (SF) of the second system (B) is continued, whereas the first step of installation of the conductors (C1-C3) of the final turn (SF) of the first system (A) ends with a number of notches (15) corresponding to a predetermined angle (β) of said stator (10).

17. Method according to claim 4, wherein said first and second steps of installation of the conductors (C1-C3, C1′-C3′) of the final turn (SF) are triggered simultaneously.
